(19) United States
(12) Patent Application Publication
(10) Pub. No.: US 2002/0089418 A1
(43) Pub. Date: Jul. 11, 2002

(54) warning device for vehicle

(76) Inventor: Jack Shy, Chang Hua (TW)

Correspondence Address: Jack Shy, 7F, No. 46, Pin Ho 10 Street, Chang Hua, 500, TW

(21) Appl. No.: 09/755,668

(22) Filed: Jan. 5, 2001

(51) Int. Cl. B60Q 1/26

(52) U.S. Cl. 340/463; 340/468

(57) ABSTRACT

A warning device includes a housing having a recess formed by a peripheral wall, a circuit board and one or more light bulbs received in the recess of the housing, and an insert received in the recess of the housing and engaged over the light bulb and the circuit board for retaining the light bulb and the circuit board in the recess of the housing. The insert may be made of silicon material for shielding and protecting the light bulbs. The circuit board may be coupled to such as the battery of the vehicle with a wire for energizing the light bulbs.

### BACKGROUND OF THE INVENTION

1. Field of the Invention

The present invention relates to a warning device, and more particularly to a warning device for vehicles.

2. Description of the Prior Art

Various kinds of typical warning devices have been developed and used for attaching onto the vehicles or the like, and comprise a plastic outer casing, and a number of light bulbs received in the plastic outer casing. The plastic outer casing includes a suitable hardness that may not be bent, such that the plastic outer casing may not be firmly secured onto the vehicle according to the shape of the outer peripheral portion of the vehicle.

The present invention has arisen to mitigate and/or obviate the afore-described disadvantages of the conventional warning devices for vehicles.

### SUMMARY OF THE INVENTION

The primary objective of the present invention is to provide a warning device for vehicles including a flexible structure for firmly attaching or securing to the outer peripheral portion of the vehicle according to the shape of the outer peripheral portion of the vehicle.

In accordance with one aspect of the invention, there is provided a warning device comprising a housing including a recess formed therein, a circuit board received in the recess of the housing, at least one light bulb attached to the circuit board and received in the recess of the housing, and an insert received in the recess of the housing and engaged over the light bulb and the circuit board for retaining the light bulb and the circuit board in the recess of the housing.

The housing and the circuit board are preferably made of flexible material for attaching onto various objects according to the various kinds of shapes of the outer peripheral portions of the objects, such as the vehicles.

The housing includes a peripheral wall extended therefrom for defining the recess in the housing and for firmly and solidly retaining the circuit board and the light bulb in the recess of the housing.

The housing includes an orifice formed therein, and includes a wire engaged through the orifice of the housing and coupled to the circuit board for coupling the circuit board to such as the battery of the vehicle and for energizing the light bulbs. The insert is preferably made of silicon material for shielding and protecting the light bulbs and for preventing the light bulbs from being disengaged from the housing and from being damaged inadvertently.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a warning device in accordance with the present invention;

FIG. 2 is a cross sectional view of the warning device, taken along lines 2-2 of FIG. 1;

FIG. 3 is a front view of a vehicle having a warning device; and

FIG. 4 is an enlarged front view of a rear view mirror of the vehicle.

### DETAILED DESCRIPTION OF THE PREFERRED EMBODIMENT

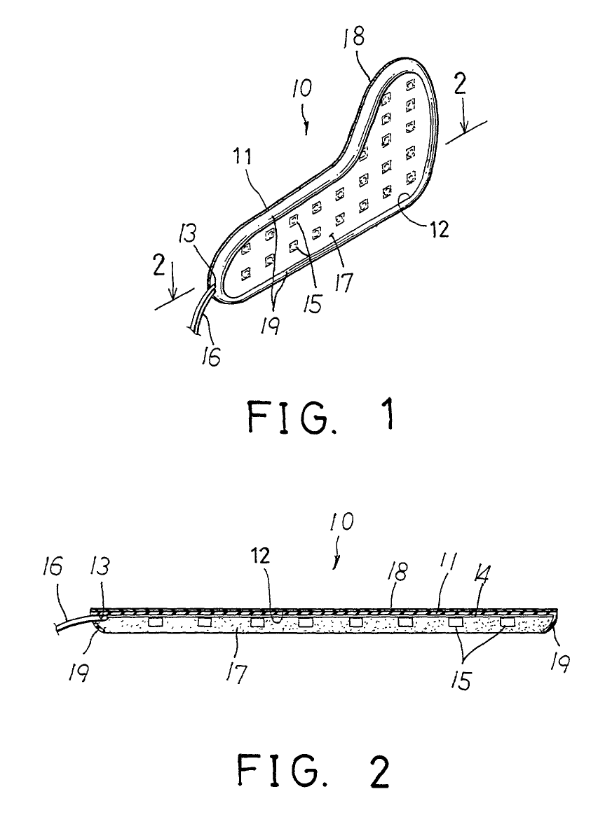

Referring to the drawings, and initially to FIGS. 1 and 2, a warning device in accordance with the present invention may be made into various kinds of shapes and comprises a housing 10 including a peripheral wall 19 extended from the peripheral portion of the base plate 11 thereof for forming or defining a chamber or recess 12 in the housing 10. A circuit board 14 is received in the recess 12 of the housing 10 and engaged with the base plate 11 of the housing 10. The housing 10 and the circuit board 14 may be made of soft or resilient or flexible rubber or synthetic materials for allowing the housing 10 and the circuit board 14 to be bent and to be firmly attached and secured onto the objects, such as the vehicle according to the shape of the outer peripheral portion of the objects or of the vehicle.

One or more light bulbs 15, such as the light crystal displayers, or the light emitting diodes, are provided and attached and coupled to the circuit board 14. An electric wire 16 or the like is engaged through an orifice 13 of the housing 10, such as the peripheral wall 19 of the housing 10 and includes one end coupled to the circuit board and includes the other end coupled to the battery of the vehicle, for example, for energizing the light bulbs 15. An insert 17, such as a transparent plastic or silicon material is then filled into the recess 12 of the housing 10 and engaged over the light bulbs 15 for shielding and protecting the light bulbs 15 and for preventing the light bulbs 15 from being disengaged from the housing 10 and from being damaged. A tape or an adhesive layer 18 may further be applied to the back portion of the plate 11 of the housing 10 for adhering the housing 10 onto the vehicle.

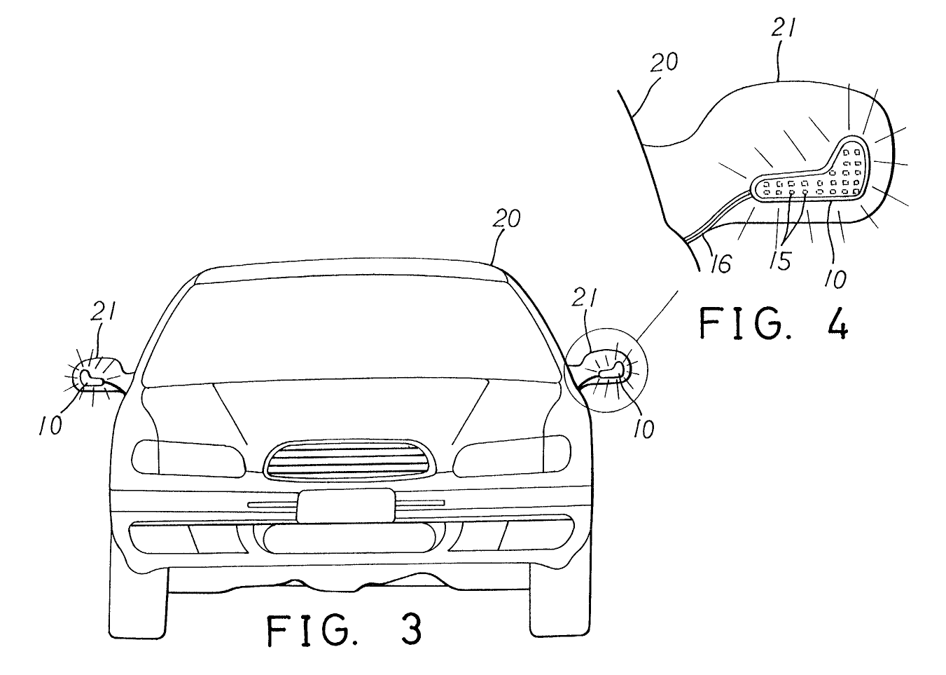

In operation, as shown in FIGS. 3, 4, the housing 10 may be attached to the rear mirror 21 of the vehicle 20, or attached to various kinds of objects, with the tape or the adhesive layer 18. The flexible housing 10 may be firmly and solidly secured onto various kinds of objects according to the outer peripheral shapes of the objects or of the vehicle.

Accordingly, the warning device in accordance with the present invention includes a flexible structure for firmly attaching or securing to the outer peripheral portion of the vehicle according to the shape of the outer peripheral portion of the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning device comprising:
a housing including a recess formed therein,
a circuit board received in said recess of said housing,
at least one light bulb attached to said circuit board and received in said recess of said housing, and
an insert received in said recess of said housing and engaged over said at least one light bulb and said circuit board for retaining said at least one light bulb and said circuit board in said recess of said housing.

2. The warning device according to claim 1, wherein said housing and said circuit board are made of flexible material for attaching onto various objects.

3. The warning device according to claim 1, wherein said housing includes a peripheral wall extended therefrom for defining said recess in said housing.

4. The warning device according to claim 1, wherein said housing includes an orifice formed therein, and includes a wire engaged through said orifice of said housing and coupled to said circuit board.

5. The warning device according to claim 1, wherein said insert is made of silicon material.
